(19) United States
(12) Patent Application Publication
(10) Pub. No.: US 2010/0289938 A1
(43) Pub. Date: Nov. 18, 2010

(54) CAMERA MODULE WITH LIGHT SCATTERING PORTION

(75) Inventor: SHIH-CHIEH YEN, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/605,429

(22) Filed: Oct. 26, 2009

(30) Foreign Application Priority Data
May 15, 2009 (CN) 200910302326.9

(51) Int. Cl. H04N 5/225

(52) U.S. Cl. 348/340; 348/374; 348/E05.024

(57) ABSTRACT

An exemplary camera module includes a lens, a lens barrel and an image sensor. The lens includes an optically active part and a peripheral part surrounding the optically active part. The lens barrel receives the lens. The lens barrel includes an inner surface, a supporting portion and a scattering portion. The inner surface is substantially perpendicular to an optical axis of the lens and faces an object surface of the lens. The supporting portion and the scattering portion are formed at the inner surface. The supporting portion provides surface area for attachment of the peripheral part thereto. The scattering portion is configured for scattering light incident thereon. The image sensor is configured for receiving light from the lens and converting the light into electrical signals.

### BACKGROUND

1. Technical Field

The present disclosure relates to imaging technology, and particularly, to camera modules with light scattering portions.

2. Description of Related Art

Typically, a camera module includes a lens barrel, a lens group received in the lens barrel, and an image sensor for receiving light from the lens group. When incident light strikes an optical surface of the lens group, parts of the incident light are reflected by the optical surface towards inner surfaces of the lens barrel. This reflected light is further reflected by the inner surfaces of the lens barrel and is finally received by the image sensor. Such reflected light may cause flare in images captured by the image sensor. That is, the imaging performance of the camera module is impaired.

Therefore, there is a need for a camera module, in which the above problems are eliminated or at least alleviated.

### BRIEF DESCRIPTION OF THE DRAWINGS

FIG. 1 is a cross-sectional view of a camera module including a lens barrel, according to an exemplary embodiment.

FIG. 2 is an enlarged, bottom plan view of the lens barrel of FIG. 1.

### DETAILED DESCRIPTION

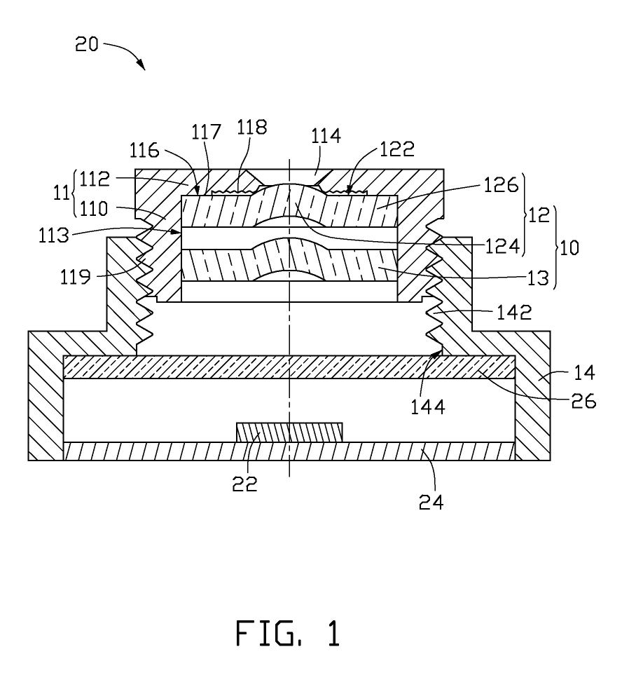

Referring to FIG. 1, a camera module 20, according to an exemplary embodiment, includes a lens barrel 11, a lens group 10, a barrel holder 14, an image sensor 22 and a circuit board 24. The lens group 10 includes, in order from the object side to the image side of the camera module 20, a first lens 12 and a second lens 13.

The lens barrel 11 is substantially a hollow cylinder. The lens barrel 11 includes a cylindrical (or annular) side wall 110, and a front cover 112 extending radially inwardly from the object end of the side wall 110. That is, the front cover 112 is substantially annular. A through hole 114 is defined in a middle of the front cover 112, and is configured for allowing light to enter the lens barrel 11. The side wall 110 includes an outer thread 119 on an outer surface thereof.

The front cover 112 includes an inner surface 116 substantially perpendicular to a central axis (shown with a broken line) of the camera module 20. An optical axis of the lens group 10 coincides with the central axis of the camera module 20, and so the inner surface 116 is substantially perpendicular to the optical axis of the lens group 10. The inner surface 116 faces an object surface 122 of the first lens 12. The front cover 112 further includes a supporting portion 117 and a scattering portion 118 both formed at the inner surface 116 of the front cover 112.

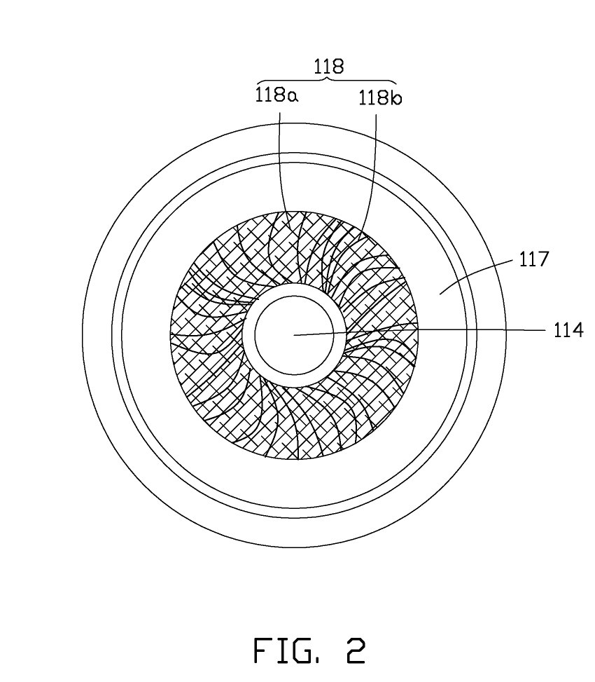

Further referring to FIG. 2, the supporting portion 117 includes an annular, planar surface, and encircles the scattering portion 118. The scattering portion 118 includes a roughened surface. In this embodiment, the scattering portion 118 includes a grid pattern component and a spiral pattern component integrated together. The grid pattern component is formed by a plurality of first elongated protrusions 118a. In detail, the grid pattern component can be considered as a series of generally parallel straight inverted ridges arranged side by side substantially continuously across an expanse of the scattering portion 118. The spiral pattern component is formed by a plurality of second elongated protrusions 118b, which are arranged generally radially relative to a center of the through hole 114. In more detail, the spiral pattern component can be considered as a series of generally parallel curved inverted ridges arranged side by side substantially continuously around the through hole 114. That is, a concave side of a ridgeline of each curved inverted ridge is generally opposite to a convex side of a ridgeline of the adjacent curved inverted ridge, and vice versa. In general, the scattering portion 118 is a microstructure pattern, which is defined herein as a structure having peak and trough features in the range from about 0.1 micrometers to about 10 micrometers as measured in a vertical direction (i.e., parallel to the central axis of the camera module 20). For a better scattering effect, the roughness of the scattering portion 118 is in a range from about 0.1 micrometers to about 1 micrometer.

The first lens 12 may be a plastic lens or a glass lens, and the second lens 13 may be a plastic lens or a glass lens. The first lens 12 includes a central optically active part 124 and a peripheral part 126. The peripheral part 126 surrounds the optically active part 124. The optically active part 124 is configured for allowing light to transmit therethrough and guiding the light to the image sensor 22. The peripheral part 126 is attached to the supporting portion 117 by adhesive, thereby supporting the first lens 12 on the lens barrel 11. Configurations and working principles of the second lens 13 are similar to those of the first lens 12.

The barrel holder 14 includes an inner thread 142 on an inner surface 144 thereof. The lens barrel 11 is screwed into the barrel holder 14 by meshing of the outer thread 119 and the inner thread 142. The lens barrel 11 and the barrel holder 14 may be made of material with low reflectivity, such as black plastic. The inner surface 116 of the lens barrel 11, an inner cylindrical surface 113 of the side wall 110 of the lens barrel 11, and the inner surface 144 of the barrel holder 14 may be coated with a light absorbing layer (not shown), such as a black resin layer, to reduce reflection capability of the inner surfaces 116, 113, 144.

The image sensor 22 is positioned on the circuit board 24, and is electrically connected to the circuit board 24. The image sensor 22 and the circuit board 24 are received in the barrel holder 14. The image sensor 22 is configured for receiving light from the lens group 10 and converting such incident light into electrical signals. The image sensor 22 can be a charge-coupled device (CCD) type image sensor, or a semiconductor package selected from the group consisting of a ceramic leaded chip carrier (CLCC) package type image sensor, a plastic leaded chip carrier (PLCC) package type image sensor, and a chip scale package (CSP) type image sensor.

The camera module 20 further includes a glass cover plate 26 received in the barrel holder 14. The glass cover plate 26 is arranged between the lens group 10 and the image sensor 22, and is configured for protecting the image sensor 22 from staining or contamination.

When light is reflected by the object surface 122 of the first lens 12 towards the inner surface 116 of the lens barrel 11, the scattering portion 118 can scatter the reflected light. Therefore, any flare in the images captured by the image sensor 22 and caused by reflected light can be eliminated or at least reduced to a minimum. That is, the imaging performance of the camera module 20 is improved.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A camera module, comprising:
a lens comprising an optically active part and a peripheral part surrounding the optically active part;
a lens barrel receiving the lens, the lens barrel comprising an inner surface, a supporting portion and a scattering portion, the inner surface substantially perpendicular to an optical axis of the lens and facing an object surface of the lens, the supporting portion and the scattering portion formed at the inner surface, the supporting portion providing surface area for attachment of the peripheral part thereto, the scattering portion configured for scattering light incident thereon; and
an image sensor configured for receiving light from the lens and converting the light into electrical signals.

2. The camera module of claim 1, wherein the supporting portion encircles the scattering portion.

3. The camera module of claim 1, wherein the scattering portion comprises a microstructure pattern.

4. The camera module of claim 1, wherein the lens barrel further comprises a cylindrical side wall, and a front cover extending radially inwardly from an object end of the side wall; a middle of the front cover has a through hole defined therein, and the through hole is configured for allowing light to enter the lens barrel.

5. The camera module of claim 4, wherein the scattering portion comprises a grid pattern component and a spiral pattern component integrated together.

6. The camera module of claim 5, wherein the grid pattern component is formed by a plurality of substantially parallel first elongated protrusions.

7. The camera module of claim 6, wherein the spiral pattern component is formed by a plurality of curved second elongated protrusions arranged generally radially relative to a center of the through hole.

8. The camera module of claim 1, further comprising a barrel holder, wherein the lens barrel is screwed into the barrel holder.

9. The camera module of claim 8, wherein the lens barrel and the barrel holder are made from black plastic.

10. The camera module of claim 8, wherein inner surfaces of the lens barrel and the barrel holder are coated with a light absorbing layer.

11. A camera module, comprising:
a lens;
a lens barrel receiving the lens, the lens barrel comprising an inner surface, and a microstructure pattern formed at the inner surface, the inner surface being substantially perpendicular to an optical axis of the lens and facing an object surface of the lens, and the microstructure pattern configured for scattering light incident thereon; and
an image sensor configured for receiving light from the lens and converting the light into electrical signals.

12. The camera module of claim 11, wherein the lens barrel comprises a cylindrical side wall, and a front cover extending radially inwardly from an object end of the side wall; a middle of the front cover has a through hole defined therein, and the through hole is configured for allowing light to enter the lens barrel.

13. The camera module of claim 12, wherein the microstructure pattern comprises a grid pattern component and a spiral pattern component integrated together.

14. The camera module of claim 13, wherein the grid pattern component is formed by a plurality of substantially parallel first elongated protrusions.

15. The camera module of claim 14, wherein the spiral pattern component is formed by a plurality of curved second elongated protrusions arranged generally radially relative to a center of the through hole.

16. The camera module of claim 11, further comprising a barrel holder, wherein the lens barrel is screwed into the barrel holder.

17. The camera module of claim 16, wherein the lens barrel and the barrel holder are made from black plastic.

18. The camera module of claim 16, wherein inner surfaces of the lens barrel and the barrel holder are coated with a light absorbing layer.
